(19) United States
(12) Patent Application Publication
(10) Pub. No.: US 2026/0331573 A1
(43) Pub. Date: Oct. 22, 2026

(54) SOLID ELECTROLYTE, METHOD OF PRODUCING SOLID ELECTROLYTE, AND BATTERY

(71) Applicants: NGK INSULATORS, LTD., Nagoya-shi (JP); NAGOYA INSTITUTE OF TECHNOLOGY, Nagoya-Shi (JP)

(72) Inventors: En YAGI, Nagoya-shi (JP); Tsutomu NISHIZAKI, Nagoya-shi (JP); Haruto TAKAHASHI, Ichinomiya-shi (JP); Masahiro OYA, Tokoname-shi (JP); Toshihiro YOSHIDA, Nagoya-shi (JP); Reona MIYAZAKI, Nagoya-shi (JP)

(73) Assignees: NGK INSULATORS, LTD., Nagoya-shi (JP); NAGOYA INSTITUTE OF TECHNOLOGY, Nagoya-Shi (JP)

(21) Appl. No.: 19/560,427

(22) Filed: Mar. 9, 2026

Related U.S. Application Data
(63) Continuation of application No. PCT/JP2023/035746, filed on Sep. 29, 2023.

(51) Int. Cl. H01M 10/0562

(52) U.S. Cl. CPC H01M 10/0562; H01M 2300/008

(57) ABSTRACT

A solid electrolyte is composed primarily of a component expressed by a composition formula of Na_{a+d}M_{b}X_{c}AₑO_{f} by using values a to f that are greater than 0, where M is an element serving as a trivalent cation, X is a halogen element, and A is a sulfur element or a phosphorus element, in which 0.8c≤(a+3b)≤1.2c and 1.6f≤(d+n×e)≤2.4f are satisfied, where n is 4 or 6 when A is a sulfur element and n is 5 when A is a phosphorus element.

### CROSS-REFERENCE TO RELATED APPLICATIONS

The present application is a continuation application of International Application No. PCT/JP2023/035746 filed on Sep. 29, 2023. The content of the application is incorporated herein by reference in its entirety.

### TECHNICAL FIELD

The present disclosure relates to a solid electrolyte and a battery.

### BACKGROUND ART

In recent years, with the development of portable equipment such as personal computers and mobile phones, demand for batteries serving as power sources of such portable equipment is increasing considerably. The batteries used for such purposes conventionally use organic electrolyte solutions that contain electrolytes dissolving in inflammable organic solvents, as media for transporting ions. The batteries containing the organic electrolyte solutions may cause safety concerns. In view of this, all-solid-state batteries that use solid electrolytes instead of organic electrolyte solutions are under development in order to ensure intrinsic safety. Since the solid electrolytes are incombustible materials, all-solid-state batteries achieve a high level of safety.

Meanwhile, demand for large-scale lithium-ion batteries that realize electric vehicles (EVs) capable of decarbonization and a stable supply of renewable energy is rapidly increasing in response to a rapid change in social realities toward achieving carbon neutrality in these days. Thus, supply concerns and rising costs of Li have also become a problem, in addition to conventional rare elements such as Co and Ni.

In view of this, Japanese Patent Application Laid-Open No. 2023-48155 (Document 1) and Japanese Patent No. 7230772 (Document 2) disclose solid electrolytes serving as Na ion conductors. The solid electrolyte according to Document 1 contains a compound expressed by NaₓM¹_{2-(y+z)}M²_{y}M³_{z}(AO₄)₃, where M¹, M², and M³ are each independently Hf, Mg, Sc, In, Y, Ca, or Zr, and A is P, Si, S, or a combination of them. In the production of the solid electrolyte according to Document 2, an Na source, a Y source, and an Si source are mixed and fired to form a fired body of Na₅YSi₄O₁₂, which is then sintered after molding. Before sintering, Na₃YSi₃O₉ power is added. International Publication WO2022/210482 (Document 3) discloses an Li-ion solid electrolyte expressed by a composition formula of Li_{a+d}M_{b}X_{c}AₑO_{f}. In this composition formula, M is an element serving as a trivalent cation, X is a halogen element, and A is a sulfur element or a phosphorus element.

In the production of the solid electrolytes according to Documents 1 and 2, high-temperature sintering (heat treatment) is necessary for densification and other purposes. In the production of batteries, when a solid electrolyte prior to sintering is mixed with a positive active material or a negative active material and then sintered, reactions between the solid electrolyte and the active material may cause high resistance. For this reason, there is demand for new Na-ion solid electrolytes that can be densified by processes such as press forming and have high ion conductivity.

### SUMMARY OF THE INVENTION

The present disclosure is intended for a solid electrolyte, and it is an object of the present disclosure to provide a solid electrolyte with high ion conductivity.

Aspect 1 of the disclosure is a solid electrolyte composed primarily of a component expressed by a composition formula of Na_{a+d}M_{b}X_{c}AₑO_{f} by using values a to f that are greater than 0, where M is an element serving as a trivalent cation, X is a halogen element, and A is a sulfur element or a phosphorus element, in which 0.8c≤(a+3b)≤1.2c and 1.6f≤(d+n× e)≤2.4f are satisfied, where n is 4 or 6 when A is a sulfur element, and n is 5 when A is a phosphorus element.

According to the disclosure, it is possible to provide a solid electrolyte with high ion conductivity.

Aspect 2 of the disclosure is the solid electrolyte according to Aspect 1, in which 0<e/(c+e)≤0.5 is satisfied in the composition formula.

Aspect 3 of the disclosure is the solid electrolyte according to Aspect 1 or 2, in which in the composition formula, 0.8d≤2e≤1.2d is satisfied when A is a sulfur element, or 0.8d≤e≤1.2d is satisfied when A is a phosphorus element.

Aspect 4 of the disclosure is the solid electrolyte according to any one of Aspects 1 to 3, in which in the composition formula, A is a sulfur element and n is 6.

Aspect 5 of the disclosure is the solid electrolyte according to any one of Aspects 1 to 4, in which in the composition formula, Mis an aluminum element and X is a fluorine element.

Aspect 6 of the disclosure is the solid electrolyte according to any one of Aspects 1 to 5, in which in measurement conducted by an X-ray diffractometer using a CuKα ray, a half-value width of a peak detected within a range of 20 from 31° to 35° is greater than or equal to 0.4°.

Aspect 7 of the disclosure is a method of producing a solid electrolyte. The method includes a) preparing a compound expressed by a composition formula of NaₐM_{b}X_{c} and a compound expressed by a composition formula of Na_{d}AₑO_{f} by using values a to f that are greater than 0, where M is an element serving as a trivalent cation, X is a halogen element, A is a sulfur element or a phosphorus element, the values a to f satisfy 0.8c≤(a+3b)≤1.2c and 1.6f≤(d+n× e)≤2.4f, n is 4 or 6 when A is a sulfur element, and n is 5 when A is a phosphorus element, and b) subjecting NaₐM_{b}X_{c} and Na_{d}AₑO_{f} to a mechanical milling process. In the operation b), a ratio of the amount of substance of Na_{d}AₑO_{f} to a total of the amount of substance of NaₐM_{b}X_{c} and the amount of substance of Na_{d}AₑO_{f} is lower than or equal to 85%.

Aspect 8 of the disclosure is a method of producing a solid electrolyte. The method includes a) preparing a first compound that is NaX, a second compound that is MX₃, and a third compound composed of Na, A, and O, where X is a halogen element, M is an element serving as a trivalent cation, and A is a sulfur element or a phosphorus element, and b) subjecting the first compound, the second compound, and the third compound to a mechanical milling process. In the operation a), 0.8c≤(a+3b)≤1.2c and 1.6f≤(d+n× e)≤2.4f are satisfied when a ratio of the amounts of substance of Na, M, and X in a mixture of the first compound and the second compound and the amounts of substance of Na, A, and O in the third compound is expressed as a:b:c:d:e:f by using values a to f that are greater than 0, where n is 4 or 6 when A is a sulfur element, and n is 5 when A is a phosphorus element, and 0<e/(c+e)≤0.5 is further satisfied.

Aspect 9 of the disclosure is the method of producing a solid electrolyte according to Aspect 7 or 8, in which 0.8d≤2e≤1.2d is satisfied when A is a sulfur element, or 0.8d≤e≤1.2d is satisfied when A is a phosphorus element.

Aspect 10 of the disclosure is the method of producing a solid electrolyte according to any one of Aspects 7 to 9, in which A is a sulfur element, and n is 6.

Aspect 11 of the disclosure is the method of producing a solid electrolyte according to any one of Aspects 7 to 10, in which Mis an aluminum element, and X is a fluorine element.

Aspect 12 of the disclosure is a battery that includes a positive electrode, a negative electrode, and an electrolyte layer provided between the positive electrode and the negative electrode. The solid electrolyte according to any one of Aspects 1 to 6 is contained in at least one of the positive electrode, the negative electrode, or the electrolyte layer.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a longitudinal section view of an all-solid-state secondary battery.

FIG. 2 is a flowchart showing a procedure for producing a solid electrolyte.

FIG. 3 is a diagram showing an X-ray diffraction pattern obtained from the solid electrolyte.

FIG. 4 is a diagram showing the relationship between the ratio of the amount of substance of Na₂SO₄ and ion conductivity at ambient temperature.

FIG. 5 is a diagram showing the relationship between the ratio of the amount of substance of Na₂SO₄ and ion conductivity at 120° C.

FIG. 6 is a flowchart showing another example of the production of the solid electrolyte.

### DETAILED DESCRIPTION

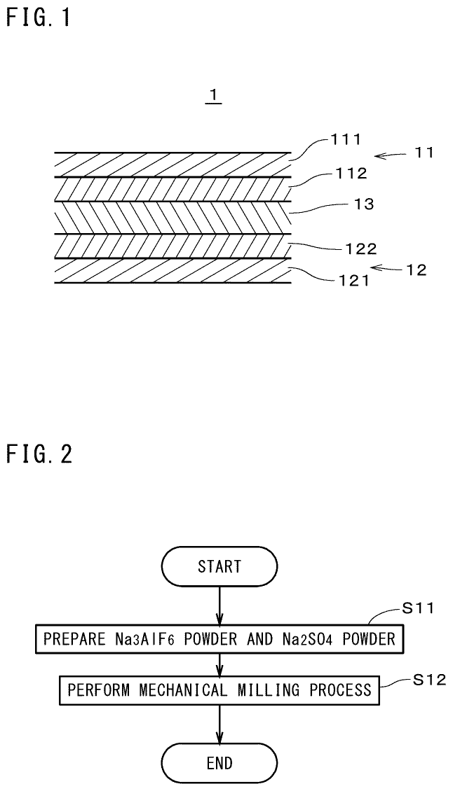

FIG. 1 is a longitudinal section view showing an all-solid-state sodium-ion secondary battery 1 (hereinafter, simply referred to as the “all-solid-state secondary battery 1”). The all-solid-state secondary battery 1 includes a positive electrode 11, a solid electrolyte layer 13, and a negative electrode 12 in order from above in FIG. 1. That is, the solid electrolyte layer 13 is positioned between the positive electrode 11 and the negative electrode 12. The solid electrolyte layer 13 serves also as a separator layer. The positive electrode 11 includes a current collector 111 and a positive electrode layer 112. The positive electrode layer 112 includes a positive active material. The negative electrode 12 includes a current collector 121 and a negative electrode layer 122. The negative electrode layer 122 includes a negative active material.

One example of the positive active material of the positive electrode layer 112 is Na(Fe, Mn)O₂. Other examples of the positive active material include layered compounds such as NaCoO₂, NaNiO₂, NaMnO₂, Na(Ni,Co,Mn)O₂, NaFeO₂, and Na(Ni, Mn, Fe, Ti)O₂, spinel-type compounds such as NaMn₂O₄, polyanion-type compounds such as Na₃V₂(PO₄)₃, Na₂Fe₂(SO₄)₃, Na₂Mn₂(SO₄)₃, NaFePO₄, NaMnPO₄, Na₄Fe₇(PO₄)₆, and Na₃V(PO₃)₃N, and pyrophosphate compounds such as Na₂MnP₂O₇ and Na₂FeP₂O₇. In addition to the positive active material, the positive electrode layer 112 includes a solid electrolyte, which will be described later. The positive electrode layer 112 may further include an electron conductive agent (e.g., carbon black). One example of the positive electrode layer 112 is obtained by integrating those substances by the application of pressure or other means.

One example of the negative active material of the negative electrode layer 122 is hard carbon. Other examples of the negative active material include metal such as Na, In, Sn, and Sb, alloys of the metal and Na, graphite, SiO, TiO₂, Fe₂O₃, Na_{4/3}Ti_{5/3}O₄, Na₂Ti₆O₁₃, Na_{0.66}[Li_{0.22}Ti_{0.78}]O₂, Na₃V₂(PO₄)₃, SnO, and Li₄Ti₅O₁₂. In addition to the negative active material, the negative electrode layer 122 includes a solid electrolyte, which will be described later.

The negative electrode layer 122 may further include an electron conductive agent (e.g., carbon black). One example of the negative electrode layer 122 is obtained by integrating those substances by the application of pressure or other means.

The configurations and materials of the positive electrode 11 and the negative electrode 12 in the all-solid-state secondary battery 1 are not limited to those described above, and may be any of other various configurations and materials.

The solid electrolyte layer 13 is composed of a solid electrolyte according to one embodiment of the present disclosure (hereinafter, also referred to as the “present solid electrolyte”), or includes the present solid electrolyte. The present solid electrolyte is a sodium-ion conductive material. For example, the present solid electrolyte may be a mixture (or a synthetic substance) of a compound that contains a sodium element (Na), an element (M) serving as a trivalent cation, and a halogen element (X) and a compound that contains a sodium element, a sulfur(S) or phosphorus (P) element, and an oxygen element (O). As will be described later, the present solid electrolyte is expressed by a composition formula of Na_{a+d}M_{b}X_{c}AₑO_{f} by using values a to f that are greater than 0, where M is an element serving as a trivalent cation, X is a halogen element, and A is a sulfur element or a phosphorus element, in which 0.8c≤(a+3b)≤1.2c and 1.6f≤(d+n× e)≤2.4f are satisfied, where n is 4 or 6 when A is a sulfur element and n is 5 when A is a phosphorus element. The present solid electrolyte has high ion conductivity (typically sodium ion conductivity). Besides, the present solid electrolyte is incombustible and chemically stable.

A preferable example of the present solid electrolyte is a mixture of Na₃AlF₆ (hexafluoro sodium aluminate) that contains a sodium element, an aluminum element, and a fluorine element, and inorganic salt Na₂SO₄ (sodium sulfate) or NaPO₃ that contains a sodium element and a sulfur or phosphorus element. The present solid electrolyte that contains Na₃AlF₆ and either Na₂SO₄ or NaPO₃ has higher ion conductivity than Na₃AlF₆ as a simple substance. The reason for this is not clear, but one conceivable factor is that an interface layer with high ion conductivity is formed at the interface of particles between Na₃AlF₆ and either Na₂SO₄ or NaPO₃ by a mechanical milling process as will be described later. The present solid electrolyte maintains high ion conductivity within a higher-temperature range, for example, at 120° C. That is, the present solid electrolyte achieves high-temperature stability.

FIG. 2 is a flowchart showing a procedure for producing the present solid electrolyte. The following description is given of processing for mixing Na₃AlF₆ and Na₂SO₄ to produce the present solid electrolyte, but the same also applies to the case of, for example, mixing Na₃AlF₆ and NaPO₃ to produce the present solid electrolyte. First, Na₃AlF₆ powder and Na₂SO₄ powder are prepared (step S11). In the preparation of the Na₃AlF₆ powder, for example, commercial NaF (sodium fluoride) powder and commercial AlF₃ (aluminum fluoride) powder are weighed and mixed together. Then, the resultant mixture is subjected to heat treatment (e.g., at 1050° C.) and thereafter pulverized into small particles to obtain the Na₃AlF₆ powder. The Na₃AlF₆ powder may be generated by any other method. The Na₂SO₄ powder is commercially available (the same applies to the NaPO₃ powder). It goes without saying that the Na₂SO₄ powder may be generated by a known method (the same applies to the NaPO₃ powder). Step S11 is the step of preparing NaₐM_{b}X_{c} and Na_{d}AₑO_{f}, which will be described later.

Then, the Na₃AlF₆ powder and the Na₂SO₄ powder are mixed and thereafter subjected to a mechanical milling process (step S12). In one example of the mechanical milling process, a planetary ball mill is used. The planetary ball mill is capable of generating very high impact energy because a stage with a pot placed thereon revolves while the pot rotates on its axis. The mechanical milling process may be conducted using any other type of pulverizer. Through the mechanical milling process described above, powder of the present solid electrolyte is obtained for use in the positive electrode layer 112, the negative electrode layer 122, or the solid electrolyte layer 13. In the present processing example, the mechanical milling process is conducted at ordinary temperatures, but conditions for the mechanical milling process such as temperature may be changed as appropriate. Step S12 is the step of subjecting NaₐM_{b}X_{c} and Na_{d}AₑO_{f} to the mechanical milling process.

In step S12, it is preferable that the ratio of the amount of substance of Na₂SO₄ to the total of the amount of substance of Na₃AlF₆ and the amount of substance of Na₂SO₄ is higher than 0% and lower than or equal to 85%. This more reliably realizes the condition that the present solid electrolyte has a higher ion conductivity than Na₃AlF₆ as a single substance at both ambient temperature and high temperatures (e.g., at 120° C.). As will be shown in experiments described later, the present solid electrolyte that contains Na₃AlF₆ and Na₂SO₄ has ion conductivity of higher than or equal to 1.0×10⁻⁵ S/cm at 120° C. if the ratio of the amount of substance of Na₂SO₄ is in the range of 15% to 85%. In order to further increase the ion conductivity of the present solid electrolyte, it is preferable that the ratio of the amount of substance of Na₂SO₄ is in the range of 20% to 75%. The same also applies to the case in which NaPO₃ is used instead of Na₂SO₄.

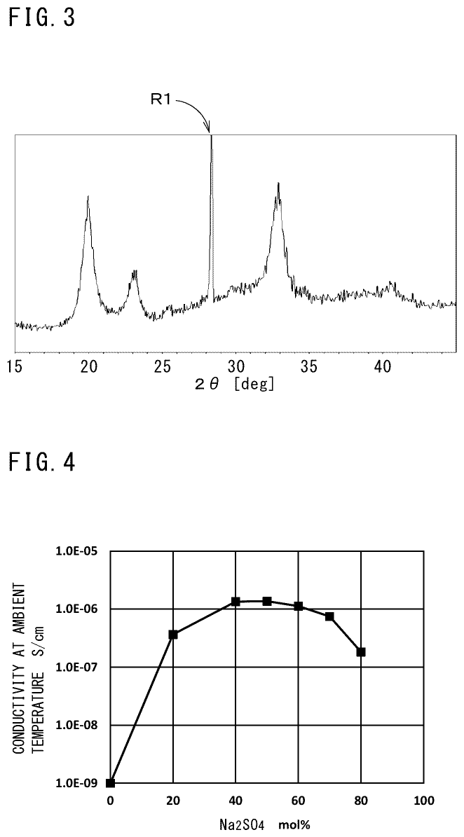

FIG. 3 is a diagram showing an X-ray diffraction (XRD) pattern obtained by measurement of the present solid electrolyte conducted by a powder X-ray diffraction method. The XRD pattern shown in FIG. 3 is obtained from a solid electrolyte that is produced by a mechanical milling process on condition that the ratio of the amount of substance of Na₂SO₄ is 50% (Experiment 4 described later). In this measurement, a CuKα ray is used as a radiation source of the X-ray diffractometer. In FIG. 3, the peak marked with R1 is a peak that originates from Si powder serving as an internal standard sample. As shown in FIG. 3, in the solid electrolyte produced by the mechanical milling process, peaks in the X-ray diffraction pattern are all broad (the same also applies to the solid electrolyte that contains Na₃AlF₆ and NaPO₃). This is considered because very high impact energy generated by the mechanical milling process may cause pulverization or partial amorphization of Na₃AlF₆ and Na₂SO₄ particles, or because the crystal structure may become disordered due to distortion or dislocation in crystals. Since such phenomena remarkably occur in particular at the interface of these particles, the present solid electrolyte is considered to have higher ion conductivity. Therefore, in order to increase the ion conductivity of the present solid electrolyte, it is preferable that the half-value widths of peaks detected within the range of 20 from 31° to 35° in the X-ray diffraction pattern are greater than or equal to 0.4° (the same also applies to the solid electrolyte that contains Na₃AlF₆ and NaPO₃). There are no particular limitations on the upper limit for the half-value widths, and the upper limit may, for example, be 3.0°. Note that the present solid electrolyte may be amorphized.

Next, experiments on the solid electrolyte is described. The following experiments were conducted in a dry room or in a glove box with a dew point of less than or equal to −40° C.

### Experiment 1

Commercial NaF (sodium fluoride) powder and commercial AlF₃ (aluminum fluoride) powder were prepared as raw materials. These raw materials were weighed and mixed so that the ratio of NaF and AlF₃ (the ratio of the amounts of substance) became 3:1. A resultant mixture was subjected to heat treatment at 1050° C. and thereafter pulverized in a mortar into Na₃AlF₆ powder. The Na₃AlF₆ powder was subjected to a mechanical milling process using a planetary ball mill to obtain solid electrolyte powder that contained only the Na₃AlF₆ powder.

### Experiment 2

In addition to the Na₃AlF₆ powder described above, commercial Na₂SO₄ powder was prepared. These raw materials were weighed so that the ratio of Na₃AlF₆ and Na₂SO₄ (the ratio of the amounts of substance) became 80:20, and were subjected to a mechanical milling process using a planetary ball mill to obtain Na₃AlF₆—Na₂SO₄ powder as solid electrolyte powder.

### Experiment 3

Solid electrolyte powder was obtained through the same processing as in Experiment 2, except that Na₃AlF₆ and Na₂SO₄ were weighed in the ratio of 60:40 (the ratio of the amounts of substance).

### Experiment 4

Solid electrolyte powder was obtained through the same processing as in Experiment 2, except that Na₃AlF₆ and Na₂SO₄ were weighed in the ratio of 50:50 (the ratio of the amounts of substance).

### Experiment 5

Solid electrolyte powder was obtained through the same processing as in Experiment 2, except that Na₃AlF₆ and Na₂SO₄ were weighed in the ratio of 40:60 (the ratio of the amounts of substance).

### Experiment 6

Solid electrolyte powder was obtained through the same processing as in Experiment 2, except that Na₃AlF₆ and Na₂SO₄ were weighed in the ratio of 30:70 (the ratio of the amounts of substance).

### Experiment 7

Solid electrolyte powder was obtained through the same processing as in Experiment 2, except that Na₃AlF₆ and Na₂SO₄ were weighed in the ratio of 20:80 (the ratio of the amounts of substance).

### Experiment 8

In addition to the Na₃AlF₆ powder described above, commercial NaPO₃ powder was prepared. Then, Na₃AlF₆ and NaPO₃ were weighed in the ratio of 50:50 (the ratio of the amounts of substance) and subjected to a mechanical milling process using a planetary ball mill so as to obtain Na₃AlF₆—NaPO₃ powder as solid electrolyte powder.

### Measurement of Ion Conductivity

The solid electrolyte powder was introduced into a mold configured by a sleeve made of resin and upper and lower punches made of stainless steel (SUS), and was subjected to uniaxial press molding by the application of pressure at 150 MPa. The upper and lower punches were connected to conductors, and ion conductivity was calculated by conducting impedance measurement at a temperature ranging from ambient temperature to 120° C.

### X-Ray Power Diffractometry

The solid electrolyte powder was analyzed by an X-ray diffractometer (XRD) using a CuKα ray to obtain an X-ray diffraction pattern. The obtained X-ray diffraction pattern was subjected to automatic fitting using XRD data analysis software JADE to calculate the half-value widths of peaks.

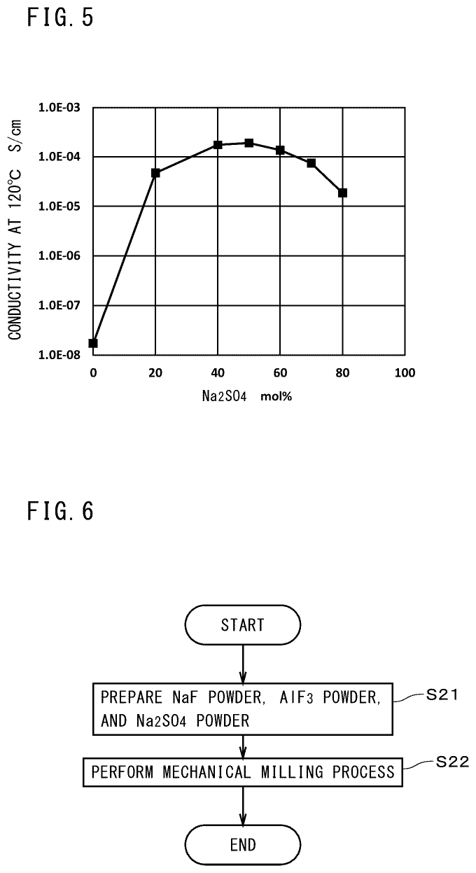

Table 1 shows the ratios of the amounts of substance of Na₃AlF₆ and either Na₂SO₄ or NaPO₃ in the solid electrolytes according to Experiments 1 to 8, ion conductivity at ambient temperature, and ion conductivity at 120° C. Table 1 also shows, for some Experiments, the half-value widths of peaks with maximum intensities within the range of 31° to 35° obtained by X-ray diffractometry. In Table 1, Experiments 2 to 8 correspond to examples according to the present disclosure, and Experiment 1 corresponds to a comparative example. FIGS. 4 and 5 are diagrams showing the relationship between the ion conductivity and the ratio (mol %) of the amount of substance of Na₂SO₄ to the total of the amount of substance of Na₃AlF₆ and the amount of substance of Na₂SO₄. FIG. 4 shows the ion conductivity at ambient temperature, and FIG. 5 shows the ion conductivity at 120° C.

TABLE 1

| | | | | | Ion | | Half- |
|---|---|---|---|---|---|---|---|
| | Base Material | | Additive | | Conductivity | Ion | Value |
| Experiment | Com- | Blended | Com- | Blended | @Ambient | Conductivity | Width |
| No. | pound | Amount | pound | Amount | Temperature | @120 °C | 31-35° |
| — | — | mol % | | mol % | S/cm | S/cm | deg. |
| 1 | Na₃AlF₆ | 100 | None | 0 | 1.0E−09 | 1.7E−08 | — |
| 2 | Na₃AlF₆ | 80 | Na₂SO₄ | 20 | 3.7E−07 | 4.7E−05 | 0.91 |
| 3 | Na₃AlF₆ | 60 | Na₂SO₄ | 40 | 1.3E−06 | 1.7E−04 | 0.94 |
| 4 | Na₃AlF₆ | 50 | Na₂SO₄ | 50 | 1.4E−06 | 1.9E−04 | 0.89 |
| 5 | Na₃AlF₆ | 40 | Na₂SO₄ | 60 | 1.1E−06 | 1.4E−04 | 0.98 |
| 6 | Na₃AlF₆ | 30 | Na₂SO₄ | 70 | 7.5E−07 | 7.4E−05 | — |
| 7 | Na₃AlF₆ | 20 | Na₂SO₄ | 80 | 1.8E−07 | 1.9E−05 | — |
| 8 | Na₃AlF₆ | 50 | NaPO₃ | 50 | 1.4E−08 | 9.3E−06 | — |

The solid electrolyte powder that contained Na₂SO₄ according to Experiments 2 to 7 and the solid electrolyte powder that contained NaPO₃ according to Experiment 8 had higher ion conductivity at both ambient temperature and 120° C. than the solid electrolyte powder that contained neither Na₂SO₄ nor NaPO₃ according to Experiment 1. To be more specific, the ion conductivity at ambient temperature and at 150° C. increased with an increase in the ratio of the amount of substance of Na₂SO₄ within a range in which the ratio of the amount of substance of Na₂SO₄ to the total of the amount of substance of Na₃AlF₆ and the amount of substance of Na₂SO₄ was relatively low (e.g., within the range of 50% or less). As the ratio of the amount of substance of Na₂SO₄ increased further, the ion conductivity decreased. However, even in Experiment 7 in which the ratio of the amount of substance of Na₂SO₄ was 80%, the ion conductivity was sufficiently higher than the ion conductivity of the solid electrolyte powder according to Experiment 1. Thus, it is conceivable that, if the ratio of the amount of substance of Na₂SO₄ is higher than 0% and lower than or equal to 85%, it is possible to ensure higher ion conductivity than that of the solid electrolyte powder according to Experiment 1.

In Experiment 2 in which the ratio of the amount of substance of Na₂SO₄ was 20%, the ion conductivity at ambient temperature was 3.7×10⁻⁷ S/cm, and the ion conductivity at 120° C. was 4.7×10⁻⁵ S/cm. In Experiment 7 in which the ratio of the amount of substance of Na₂SO₄ was 80%, the ion conductivity at ambient temperature was 1.8×10⁻⁷ S/cm, and the ion conductivity at 120° C. was 1.9×10⁻⁵ S/cm. Thus, it is conceivable that, if the ratio of the amount of substance of Na₂SO₄ is in the range of 15% to 85%, it is possible to ensure the ion conductivity of approximately 1.0×10⁻⁷ S/cm or higher at ambient temperature and the ion conductivity of approximately 1.0×10⁻⁵ S/cm or higher at 120° C. In order to further increase the ion conductivity, the ratio of the amount of substance of Na₂SO₄ is preferably in the range of 20% to 75%. The solid electrolyte powder according to Experiments 2 to 8 maintained high ion conductivity even after retained at 120° C. for some time, e.g., for 15 hours. In this way, the solid electrolyte powder according to the examples of the present disclosure achieved high-temperature stability.

The solid electrolyte powder according to Experiments 2 to 5 exhibited X-ray diffraction patterns with very broad peaks, in which the half-value widths of peaks with maximum intensities detected within the range of 31° to 35° were in the range of 0.89° to 0.98°.

### Preparation of All-Solid-State Battery

Positive active material powder that was Na(Fe, Mn)O₂, solid electrolyte powder, and electron conductive agent powder were weighed and mixed to obtain blended powder of the positive electrode. Also, negative active material powder that was hard carbon, solid electrolyte powder, and electron conductive agent powder were weighed and mixed to obtain blended powder of the negative electrode. The solid electrolyte powder was introduced into a mold configured by a sleeve made of PEEK resin and upper and lower punches made of SUS, and was subjected to uniaxial press molding by the application of pressure at 150 MPa. The blended powder of the positive electrode was introduced on the pressed solid electrolyte powder and integrated together by the application of pressure at 150 MPa. The blended powder of the negative electrode was introduced on the opposite side of the pressed solid electrolyte powder to the positive electrode and integrated together by the application of pressure at 150 MPa. In this way, a battery configured by a positive electrode layer, a solid electrolyte layer, and a negative electrode layer was prepared.

### Charge/Discharge Test

After conductors were connected to the upper and lower punches, the battery described above was placed stationary in a constant-temperature bath kept at 120° C. in order to conduct a cc-cv (constant current-constant voltage) charge/discharge test. In the charge/discharge test, the cc current density was set to 300 μA/cm², the cv current density was set to 30 μA/cm², and the cut-off voltage was set in the range of 4.25V to 1.50V. In a battery using the solid electrolyte powder according to Experiment 1 (comparative example), the discharge capacity was less than 0 mAh/g per positive active material. That is, resistance was too high for charging and discharging. In a battery using the solid electrolyte powder according to Experiment 4 (example), the discharge capacity was 25 mAh/g per positive active material.

In the present embodiment described above, the present solid electrolyte is obtained by subjecting Na₃AlF₆ and inorganic salt of either Na₂SO₄ or NaPO₃ to a mechanical milling process. However, the present solid electrolyte may be produced by mixing an arbitrary compound that contains a sodium element (Na), an element serving as a trivalent cation, and a halogen element with arbitrary inorganic salt that contains a sodium element and a sulfur or phosphorus element. In this case, the compound described above can be expressed by a composition formula of NaₐM_{b}X_{c}, where Mis an aluminum (Al) element or any other element serving as a trivalent cation (typically, a metallic element), X is a fluorine (F) element or any other halogen element, and a to c are values greater than 0. Here, Na, M, and X are a univalent cation, a trivalent cation, and a univalent anion, respectively, and the above-described compound is expressed by Na₃MX₆. In Na₃MX₆, a+3b=c and a=3b are satisfied. In addition to Na₃AlF₆, other examples of the compound described above include Na₃YF₆, Na₃LaF₆, Na₃GaF₆, Na₃YCl₆, Na₃YBr₆, Na₃InCl₆, and Na₃LaI₆.

Similarly, the inorganic salt described above can be expressed by a composition formula of Na_{d}AₑO_{f}, where A is a sulfur or phosphorus element, and d to fare values greater than 0. When A is a sulfur element, Na, A, and O are a univalent cation, a tetravalent or hexavalent cation, and a bivalent anion, respectively, and therefore d+4e=2f or d+6e=2f need to be satisfied. When A is a phosphorus element, Na, A, and O are a univalent cation, a pentavalent cation, and a bivalent anion, respectively, and therefore d+5e=2f needs to be satisfied. In other words, d+n×e=2f needs to be satisfied, where n is 4 or 6 when A is a sulfur element, and n is 5 when A is a phosphorus element. In addition to Na₂SO₄ or NaPO₃, other examples of the inorganic salt described above include Na₂SO₃ (sodium sulfite) and Na₃PO₄ (sodium orthophosphate).

In this way, in the case where the compound that contains a sodium element (Na), an element (M) serving as a trivalent cation, and a halogen element (X) is expressed by NaₐM_{b}X_{c} and inorganic salt that contains a sodium element and a sulfur or phosphorus element is expressed by Na_{d}AₑO_{f}, by using the values a to f that are greater than 0, the present solid electrolyte obtained by mixing the compound and the inorganic salt is expressed by a composition formula of Na_{a+d}M_{b}X_{c}AₑO_{f}. Moreover, the previously described conditions, i.e., a+3b=c, a=3b, and d+n×e=2f, are satisfied, where n is 4 or 6 when A is a sulfur element, and n is 5 when A is a phosphorus element. If consideration is given to factors such as measurement errors, it is enough if 0.8c≤(a+3b)≤1.2c, 0.8a≤3b≤1.2a, and 1.6f≤(d+n× e)≤2.4f are satisfied. Preferably, 0.9c≤(a+3b)≤1.1c, 0.9a≤3b≤1.1a, and 1.8f≤(d+n× e)≤2.2f are satisfied. Accordingly, the present solid electrolyte expressed by the composition formula of Na_{a+d}M_{b}X_{c}AₑO_{f} has high ion conductivity. As a result, it is possible to provide an all-solid-state secondary battery with high output. As will be described later, if the compound NaₐM_{b}Xₑ is not generated, there is no need to satisfy 0.8a≤3b≤1.2a.

Among the solid electrolytes, like sulfide-based ones, materials that react with moisture and generate hydrogen sulfide gas are widely known. Meanwhile, oxide-based solid electrolytes that do not generate gas such as hydrogen sulfide are also being developed widely. However, such solid electrolytes have the problem of reacting with active materials and increasing in resistance during the production of batteries because high-temperature sintering is necessary for densification in order to improve ion conductivity. In contrast, the present solid electrolyte is incombustible and chemically stable, thereby making it possible to provide an intrinsically safe ion battery. Besides, the present solid electrolyte can be densified by the pressure of press forming, not sintering. This prevents the present solid electrolyte from reacting with active materials during the production of batteries. Moreover, the negative electrode capable of stable charging and discharging can be formed even when using the negative active material with a low operating potential, such as graphite. Since the present solid electrolyte uses an Na element that is low in cost and has no resource risks, it is possible to provide an all-solid-state secondary battery that is low in cost and that can be supplied in large quantities.

As described previously, if the ratio of the amount of substance of Na₂SO₄ to the total of the amount of substance of Na₃AlF₆ and the amount of substance of Na₂SO₄ is lower than or equal to 85%, it is possible to more reliably make the present solid electrolyte has higher ion conductivity than Na₃AlF₆ as a single substance. This relationship is considered to also apply to the solid electrolyte expressed by a composition formula of Na_{a+d}M_{b}X_{c}AₑO_{f} and generated from an arbitrary compound and arbitrary inorganic salt. When the ratio of the amount of substance of the above-described inorganic salt (e.g., Na₂SO₄) is 85%, e/(c+e) in the above-described composition formula of Na_{a+d}M_{b}X_{c}AₑO_{f} becomes 0.49. Accordingly, if the composition formula of Na_{a+d}M_{b}X_{c}AₑO_{f} satisfies 0<e/(c+e)≤0.5, it is possible to more reliably make the present solid electrolyte have higher ion conductivity than NaₐM_{b}X_{c} as a simple substance. As described previously, the solid electrolyte contains Na_{d}AₑO_{f}, where a to f are values that are greater than 0. Depending on the ion conductivity required in the solid electrolyte, e/(c+e) may be greater than 0.5.

In order to further increase the ion conductivity by setting the ratio of the amount of substance of the above-described inorganic salt in the range of 15% to 85%, it is preferable that the composition formula of Na_{a+d}M_{b}X_{c}AₑO_{f} satisfies 0.03≤e/(c+e)≤0.5. In order to yet further increase the ion conductivity by setting the ratio of the amount of substance of the above-described inorganic salt in the range of 20 to 75%, it is preferable that the composition formula of Na_{a+d}M_{b}X_{c}AₑO_{f} satisfies 0.04≤e/(c+e)≤0.33.

Preferably, Na_{d}AₑO_{f} is Na₂SO₄ or NaPO₃. This more reliably achieves high ion conductivity. In the case where Na_{d}AₑO_{f} is Na₂SO₄, in the composition formula of Na_{a+d}M_{b}X_{c}AₑO_{f}, A is a sulfur element, and d=2e is satisfied. With consideration given to factors such as measurement errors, it is enough if 0.8d≤2e≤1.2d is satisfied, and preferably 0.9d≤2e≤1.1d is satisfied. In the case where Na_{d}AₑO_{f} is NaPO₃, in the composition formula of Na_{a+d}M_{b}X_{c}AₑO_{f}, A is a phosphorus element, and d=e is satisfied. With consideration given to factors such as measurement errors, it is enough if 0.8d≤e≤1.2d is satisfied, and preferably 0.9d≤e≤1.1d is satisfied. Moreover, NaₐM_{b}X_{c} is preferably Na₃AlF₆. In other words, in the composition formula of Na_{a+d}M_{b}X_{c}AₑO_{f}, Mis an aluminum element and X is a fluorine element. This more reliably achieves high ion conductivity.

As described previously, the composition formula of the present solid electrolyte is expressed as Na_{a+d}M_{b}X_{c}AₑO_{f}. For example, in the case where Na₃AlF₆ and Na₂SO₄ are mixed together, this composition formula is expressed as Na_{a+d}Al_{b}F_{c}SₑO_{f}. In the case where Na₃AlF₆ and NaPO₃ are mixed together, this composition formula is expressed as Na_{a+d}Al_{b}F_{c}PₑO_{f}. To identify whether an unknown solid electrolyte is the present solid electrolyte, chemical analysis is conducted on the unknown solid electrolyte to identify whether the unknown solid electrolyte contains Na, M, X, A, and O as its components, where Mis an element serving as a trivalent cation, X is a halogen element, and A is a sulfur or phosphorus element. If the unknown solid electrolyte is composed of Na, M, X, A, and O and the values a to f in the molar ratio of the components are all greater than 0 and satisfy 0.8c≤(a+3b)≤1.2c and 1.6f≤(d+n× e)≤2.4f, where n is 4 or 6 when A is a sulfur element and n is 5 when A is a phosphorus element, the unknown solid electrolyte can be said as the present solid electrolyte. If 0<e/(c+e)≤0.5 is satisfied, it can be said that the ratio of the amount of substance of the above-described inorganic salt to the total of the amount of substance of the above-described compound (e.g., Na₃AlF₆) and the amount of substance of the above-described inorganic salt (e.g., Na₂SO₄) is lower than or equal to 85%.

For example, Na, Al, S, and P can be quantitated by an ICP emission spectral analyzer, and F can be quantitated by ion chromatography. O can be quantitated by oxygen/nitrogen gas analysis. In the case where the present solid electrolyte contains an element M other than Al and an element X other than F, a measurement method capable of quantitating the elements M and X is appropriately selected.

In the above processing example, a case is described in which, after Na₃AlF₆ is generated by mixing NaF and AlF₃ in the ratio of 3:1, Na₃AlF₆ and Na₂SO₄ (or NaPO₃) are subjected to the mechanical milling process. Alternatively, NaF, AlF₃, and Na₂SO₄ (or NaPO₃) may be subjected to the mechanical milling process without generating Na₃AlF₆.

FIG. 6 is a flowchart showing another example of the production of the present solid electrolyte. In the present production example, NaF powder, AlF₃ powder, and Na₂SO₄ (or NaPO₃) powder are prepared (step S21). Then, the NaF powder, the AlF₃ powder, and the Na₂SO₄ (or NaPO₃) powder are mixed together and thereafter subjected to a mechanical milling process (step S22).

At this time, the ratio of the amounts of substance of NaF and AlF₃ may be other than 3:1. The ratio of the amount of substance of NaF to the total of the amounts of substance of NaF, AlF₃, and Na₂SO₄ is, for example, higher than or equal to 10% and lower than or equal to 80% and preferably higher than or equal to 30% and lower than or equal to 70%. The ratio of the amount of substance of AlF₃ is, for example, higher than or equal to 5% and lower than or equal to 60% and preferably higher than or equal to 10% and lower than or equal to 50%. The ratio of the amount of substance of Na₂SO₄ is, for example, higher than or equal to 2% and lower than or equal to 50% and preferably higher than or equal to 10% and lower than or equal to 40%. Through the above-described processing, it is possible to obtain the powder of the present solid electrolyte with high ion conductivity. The same also applies to the case in which NaPO₃ is used instead of Na₂SO₄.

Here, the ratio of the amounts of substance of Na, Al, and F in a mixture obtained by mixing only NaF and AlF₃ prepared in step S21 is expressed as a:b:c, where a to c are values greater than 0. In this case, Na, Al, and F are an univalent cation, a trivalent cation, and an univalent anion, respectively, and a+3b=c is satisfied. With consideration given to factors such as measurement errors, 0.8c≤(a+3b)≤1.2c is satisfied. Meanwhile, unlike in the case where Na₃AlF₆ is generated in advance, the ratio of the amounts of substance of NaF and AlF₃ is not limited to 3:1, and therefore a=3b is not always satisfied. In other words, even if 0.8a≤3b≤1.2a is not satisfied, it is possible to obtain the present solid electrolyte with high ion conductivity (and high-temperature stability).

In the production of the solid electrolyte shown in FIG. 6, as described previously, the present solid electrolyte is obtained by subjecting NaF, AlF₃, and Na₂SO₄ to the mechanical milling process. However, the raw materials for the present solid electrolyte are not limited to NaF, AlF₃, and Na₂SO₄ (or NaPO₃). The present solid electrolyte may be produced by mixing a first compound that is NaX, a second compound that is MX₃, and a third compound that is composed of Na, A, and O, where X is an arbitrary halogen element, M is an arbitrary element serving as a trivalent cation, and A is a sulfur or phosphorus element. In this case, in step S21 shown in FIG. 6, the first, second, and third compounds described above are prepared. In step S22, the first, second, and third compounds are subjected to a mechanical milling process to obtain the present solid electrolyte.

In the case where the ratio of the amounts of substance of Na, M, and X in a mixture of the first and second compounds and the amounts of substance of Na, A, and O in the third compound is expressed as a:b:c:d:e:f by using values a to f that are greater than 0, the mixture satisfies 0.8c≤(a+3b)≤1.2c as described previously. In the third compound, 1.6f≤(d+n×e)≤2.4f is satisfied as described previously, where n is 4 or 6 when A is a sulfur element, and n is 5 when A is a phosphorus element. In addition to NaF, other examples of the first compound NaX include NaCl and NaBr. In addition to AlF₃, other examples of the second compound MX₃ include YF₃, LaF₃, and GaF₃. In addition to Na₂SO₄ or NaPO₃, other examples of the third compound Na_{d}AₑO_{f} include Na₂SO₃ (sodium sulfite) and Na₃PO₄ (sodium orthophosphate).

In the production of the solid electrolyte shown in FIG. 6 as well, it is possible to obtain the present solid electrolyte whose composition formula is expressed as Na_{a+d}M_{b}X_{c}AₑO_{f} and which has high ion conductivity. It is also preferable that 0<e/(c+e)≤0.5 is satisfied. This more reliably achieves high ion conductivity. There are no particular limitations on the mixing ratio of the first compound NaX and the second compound MX₃, it is preferable that 0.1a≤3b≤10a is satisfied in order to more reliably achieve high ion conductivity.

The present solid electrolyte, the method of producing the present solid electrolyte, and the battery may be modified in various ways.

The present solid electrolyte may contain impurities and contain a component expressed by the composition formula of Na_{a+d}M_{b}X_{c}AₑO_{f} as its principal component. The principal component refers to a component with a highest mass ratio among the components of the solid electrolyte. The mass ratio of the principal component in the solid electrolyte is preferably higher than or equal to 80% by mass and more preferably higher than or equal to 90% by mass. The present solid electrolyte may be mixed with other substances (which may include Na) and used as an electrolyte material. The mass ratio of the present solid electrolyte in the electrolyte material is preferably higher than or equal to 50% by mass, more preferably higher than or equal to 60% by mass, and yet more preferably higher than or equal to 70% by mass.

In the X-ray diffraction pattern obtained from the present solid electrolyte, the half-value width of peak detected within the range of the diffraction angle of 2θ from 31° to 35° may be less than 0.4°.

The solid electrolyte layer 13 may contain substances other than the present solid electrolyte. The present solid electrolyte used in the all-solid-state secondary battery 1 does not necessarily have to be contained in all of the positive electrode 11, the negative electrode 12, and the solid electrolyte layer 13, and may be contained in at least one of the positive electrode 11, the negative electrode 12, or the solid electrolyte layer 13. The present solid electrolyte may be used in batteries other than all-solid-state secondary batteries, and may be used for purposes other than batteries. The production of the present solid electrolyte may be conducted by a process other than the mechanical milling process.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

REFERENCE SIGNS LIST

| | |
|---|---|
| 1 | all-solid-state sodium-ion secondary battery |
| 11 | positive electrode |
| 12 | negative electrode |
| 13 | solid electrolyte layer |
| S11, S12, S21, S22 | step |

1. A solid electrolyte composed primarily of a component expressed by a composition formula of Na_{a+d}M_{b}X_{c}AₑO_{f} by using values a to f that are greater than 0, where M is an element serving as a trivalent cation, X is a halogen element, and A is a sulfur element or a phosphorus element,
wherein 0.8c≤(a+3b)≤1.2c and 1.6f≤(d+n×e)≤2.4f are satisfied, where n is 4 or 6 when A is a sulfur element, and n is 5 when A is a phosphorus element.

2. The solid electrolyte according to claim 1, wherein
0<e/(c+e)≤0.5 is satisfied in said composition formula.

3. The solid electrolyte according to claim 1, wherein
in said composition formula, 0.8d≤2e≤1.2d is satisfied when A is a sulfur element, or 0.8d≤e≤1.2d is satisfied when A is a phosphorus element.

4. The solid electrolyte according to claim 1, wherein
in said composition formula, A is a sulfur element and n is 6.

5. The solid electrolyte according to claim 1, wherein
in said composition formula, M is an aluminum element and X is a fluorine element.

6. The solid electrolyte according to claim 1, wherein
in measurement conducted by an X-ray diffractometer using a CuKα ray, a half-value width of a peak detected within a range of 20 from 31° to 35° is greater than or equal to 0.4°.

7. A method of producing a solid electrolyte, comprising:
a) preparing a compound expressed by a composition formula of NaₐM_{b}X_{c} and a compound expressed by a composition formula of Na_{d}AₑO_{f} by using values a to f that are greater than 0, where M is an element serving as a trivalent cation, X is a halogen element, A is a sulfur element or a phosphorus element, the values a to f satisfy 0.8c≤(a+3b)≤1.2c and 1.6f≤(d+n× e)≤2.4f, n is 4 or 6 when A is a sulfur element, and n is 5 when A is a phosphorus element; and
b) subjecting NaₐM_{b}X_{c} and Na_{d}AₑO_{f} to a mechanical milling process,
wherein, in said operation b), a ratio of the amount of substance of Na_{d}AₑO_{f} to a total of the amount of substance of NaₐM_{b}X_{c} and the amount of substance of Na_{d}AₑO_{f} is lower than or equal to 85%.

8. The method of producing a solid electrolyte according to claim 7, wherein
0.8d≤2e≤1.2d is satisfied when A is a sulfur element, or
0.8d≤e≤1.2d is satisfied when A is a phosphorus element.

9. The method of producing a solid electrolyte according to claim 7, wherein
A is a sulfur element, and n is 6.

10. The method of producing a solid electrolyte according to claim 7, wherein
M is an aluminum element, and X is a fluorine element.

11. A method of producing a solid electrolyte, comprising:
a) preparing a first compound that is NaX, a second compound that is MX₃, and a third compound composed of Na, A, and O, where X is a halogen element, M is an element serving as a trivalent cation, and A is a sulfur element or a phosphorus element; and
b) subjecting said first compound, said second compound, and said third compound to a mechanical milling process,
wherein, in said operation a), 0.8c≤(a+3b)≤1.2c and 1.6f≤(d+n× e)≤2.4f are satisfied when a ratio of the amounts of substance of Na, M, and X in a mixture of said first compound and said second compound and the amounts of substance of Na, A, and O in said third compound is expressed as a:b:c:d:e:f by using values a to f that are greater than 0, where n is 4 or 6 when A is a sulfur element, and n is 5 when A is a phosphorus element, and
0<e/(c+e)≤0.5 is further satisfied.

12. The method of producing a solid electrolyte according to claim 11, wherein
0.8d≤2e≤1.2d is satisfied when A is a sulfur element, or
0.8d≤e≤1.2d is satisfied when A is a phosphorus element.

13. The method of producing a solid electrolyte according to claim 11, wherein
A is a sulfur element, and n is 6.

14. The method of producing a solid electrolyte according to claim 11, wherein
M is an aluminum element, and X is a fluorine element.

15. A battery comprising:
a positive electrode;
a negative electrode; and
an electrolyte layer provided between said positive electrode and said negative electrode,
wherein the solid electrolyte according to claim 1 is contained in at least one of said positive electrode, said negative electrode, or said electrolyte layer.
